(19) United States
(12) Patent Application Publication
(10) Pub. No.: US 2026/0165473 A1
(43) Pub. Date: Jun. 18, 2026

(54) BRACKET CLAMP FOR ACCESSORY RACK

(71) Applicant: Stanley Black & Decker MEA FZE, Dubai (AE)

(72) Inventor: Te-Sheng Liu, Taichung City (TW)

(21) Appl. No.: 18/982,757

(22) Filed: Dec. 16, 2024

(51) Int. Cl. A47B 96/06; F16B 2/10

(52) U.S. Cl. CPC A47B 96/06; F16B 2/10

(57) ABSTRACT

A bracket clamp for engaging with a rail. The bracket clamp has a first hook which fits over a first edge of the rail, and a rotatable second hook which rotates while engaging or disengaging the second edge of the rail. The rotatable second hook has a trough which contacts the second edge while the rotatable second hook engages with the second edge of the rail, and a tongue which contacts the interior side of the bracket, the tongue coupling with a snap protrusion on the interior side of the bracket when the bracket clamp engages the rail.

### BACKGROUND

### 1. Technical Field

The present disclosure relates to storage systems, and more specifically to brackets clamps which attach to rails.

### 2. Introduction

Wall storage systems for garages and sheds has evolved over time. For example, in the past individuals looking to organize their garage by mounting tools, equipment, toys, etc. on their garage walls may have placed nails into their garage walls. By contrast, those same individuals may now purchase rail systems which mount to the wall, and bracket clamps which couple to the rail. The bracket clamps can have hooks or other holding mechanisms, allowing the individuals to store their items on the wall, while also allowing the individuals to move the bracket clamps, swap out the bracket clamps, or otherwise customize and update their storage system as needed.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are bracket clamps for wall storage systems. A bracket clamp for performing the concepts disclosed herein can include: a first side which, while the bracket clamp engages the rail, is oriented toward the rail; a second side which, while the bracket clamp engages the rail, is oriented away from the rail; and a snap protrusion extending from the first side; a first hook attached to a first end of the bracket, the first hook configured to be placed over a first edge of the rail; a rotatable second hook attached to a second end of the bracket, wherein: the rotatable second hook is configured to: engage with a second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket, the tongue coupling with the snap protrusion when the bracket clamp engages the rail.

A wall storage system for performing the concepts disclosed herein can include: a rail, the rail comprising: a first edge of the rail; and a second edge of the rail; and a bracket clamp, the bracket clamp comprising: a first side which, while the bracket clamp engages the rail, is oriented toward the rail; a second side which, while the bracket clamp engages the rail, is oriented away from the rail; and a snap protrusion extending from the first side; a first hook attached to a first end of the bracket clamp, the first hook configured to be placed over the first edge of the rail; a rotatable second hook attached to a second end of the bracket clamp, wherein the rotatable second hook is configured to: engage with the second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket clamp, the tongue coupling with the snap protrusion when the bracket clamp engages the rail.

A bracket clamp for performing the concepts disclosed herein can include the bracket clamp comprising: a first side which, while the bracket clamp engages the rail, is oriented toward the rail; a second side which, while the bracket clamp engages the rail, is oriented away from the rail; and a snap protrusion extending from the first side; a first hook attached to a first end of the bracket clamp, the first hook configured to be placed over a first edge of the rail; a rotatable second hook attached to a second end of the bracket clamp, wherein the rotatable second hook is configured to: engage with a second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket clamp, the tongue coupling with the snap protrusion when the bracket clamp engages the rail, the tongue maintaining the rotatable second hook in an open position prior to engaging with the second edge of the rail, the tongue comprises a rectangular opening such that the snap protrusion couples to the tongue by fitting into the rectangular opening.

### BRIEF DESCRIPTION OF THE DRAWINGS

FIG. 1A illustrates a first example of a bracket clamp engaging a rail;

FIG. 1B illustrates a second example of the bracket clamp engaging the rail;

FIG. 1C illustrates a third example of the bracket clamp engaging the rail;

FIG. 2A illustrates a first example of the bracket clamp assembly;

FIG. 2B illustrates a second example of the bracket clamp assembly;

FIG. 3 illustrates an example of the bracket clamp without a lower hook;

FIG. 4 illustrates an example of a rotatable second hook;

FIG. 5A illustrates an example of a bracket clamp engaging a first edge of a rail;

FIG. 5B illustrates an example of the bracket clamp engaging a second edge of the rail;

FIG. 5C illustrates an example of the bracket clamp coupled to the first and second edges of the rail;

FIG. 5D illustrates an example of a segmented bracket clamp engaging a first edge of a rail;

FIG. 5E illustrates an example of the segmented bracket clamp engaging a second edge of the rail;

FIG. 5F illustrates an example of the segmented bracket clamp coupled to the first and second edges of the rail;

FIG. 6A illustrates a first example of a bracket clamp disengaging the second edge of the rail;

FIG. 6B illustrates a second example of the bracket clamp disengaging the second edge of the rail;

FIG. 6C illustrates a first example of a segmented bracket clamp disengaging the second edge of the rail;

FIG. 6D illustrates a second example of the segmented bracket clamp disengaging the second edge of the rail;

FIG. 7A illustrates an example side view of a segmented bracket clamp with the tongue locked in place;

FIG. 7B illustrates an example perspective view of a segmented bracket clamp with the tongue locked in place;

FIG. 7C illustrates an example side view of a segmented bracket clamp with the rotatable second hook in an open position; and

FIG. 7D illustrates an example perspective view of a segmented bracket clamp with the rotatable second hook in an open position.

### DETAILED DESCRIPTION

Various embodiments of the disclosure are described in detail below. While specific implementations are described, this is done for illustration purposes only. Other components and configurations may be used without parting from the spirit and scope of the disclosure.

Bracket clamps configured as disclosed herein have a rotatable hook which, as the bracket clamp engages a rail, rotates toward the bracket body, the rotatable hook eventually locking in place to hold the bracket clamp to the rail. When a user desires to release the bracket from the rail, the user can pull an elastic arm which releases the rotatable hook, thereby allowing the rotatable hook to again rotate, such that the bracket clamp releases from the rail.

The bracket clamp has a first hook which attaches to a first edge of the rail, and a rotatable second hook which engages with a second edge of the rail. A bracket connects the first hook and the rotatable second hook. Preferably, the first edge of the rail is the top edge, and the second edge of the rail is the bottom edge, such that as the bracket clamp couples to the rail the first hook couples to the first edge, and the rotatable second hook is coupled to the second edge. The result is that the bracket clamp locks (i.e., clamped) onto the rail.

The bracket clamp can be made of plastic, metal, other materials, or any combination thereof. The bracket portion of the bracket clamp, which connects the first hook to the rotatable second hook can, in some configurations, be a flat piece of material. Preferably, however, the bracket has support ridges on the side which faces the rail (i.e., the “inside” of the bracket). The other side of the bracket (i.e., the “outside” of the bracket) can, in some configurations, be configured to have additional hooks, clamps, or other coupling devices which, when the bracket clamp is coupled to the rail, can allow the bracket clamp to hold tools, bikes, or other items in one's garage or shed.

The first hook extends from the bracket portion at one end of the bracket (preferably the top end) in a C shape, forming a hook which first extends away from the bracket portion on the inside (i.e., towards the rail), then slightly towards the second end of the bracket (preferably the bottom end), which is also towards the rotatable second hook.

At the second end of the bracket are two arms which extend away from the bracket portion on the inside (i.e., towards the rail). Each arm has a specially shaped hole which is configured to receive shafts extending from the rotatable second hook. These specially shaped holes in each arm are designed to limit the arc through which the rotatable second hook can rotate. On the inside of the bracket, near the second end, is a snap protrusion which extends away from the bracket portion on the inside, though not to the same distance from the bracket as the arms. The snap protrusion is designed to lock in the rotatable second hook in place.

The rotatable second hook has a trough (i.e., the portion which rotates into place to engage with the second edge of the rail), a pair of specially shaped shafts, and a tongue with a rectangular opening therein. The pair of specially shaped shafts fit within the specially shaped holes of the arms, coupling the rotatable second hook to the bracket. Preferably, the specially shaped holes are formed as a first circle, with a second/additional/larger radius semi-circle contiguous to the first circle, both the first circle and the second semi-circle having a common center. Likewise, the specially shaped shafts formed as a first circle, with a second/additional/larger radius semi-circle contiguous to the first circle, both the first circle and the second semi-circle having a common center. The semi-circular area of the shafts is smaller than the semi-circular area of the holes, allowing the rotatable second hook to rotate through a predetermined arc. For example, in some configurations, the semi-circular areas of the shaft and the holes allows the rotatable second hook to have an arc of rotation of 60°, whereas in other configurations the arc of rotation can be 45°. Other arcs of rotation are likewise possible. This limited arc of rotation is particularly useful in preventing the rotatable second hook from rotating away from the bracket portion.

The tongue, with a rectangular opening therein, extends from the rotatable second hook towards the bracket portion. The tongue helps maintain the rotatable second hook in position as the user places the bracket clamp on the rail, not letting the rotatable second hook rotate prematurely towards the bracket portion. More specifically, the tongue presses against the snap protrusion on the inside of the bracket portion, such that (1) the rotatable second hook will not turn too far away from the bracket portion due to the limited arc of rotation provided by the shafts and holes coupling the rotatable second hook to the bracket; and (2) the rotatable second hook will not turn too far towards the bracket portion until pressure is applied. Only once the user begins exerting force on the bracket (e.g., as the user presses the bracket clamp into the rail, coupling the bracket clamp to the rail) does the tongue move, allowing rotation of the rotatable second hook.

To couple the bracket clamp to the rail, the user first places the first hook over the first edge of the rail (e.g., hangs the first hook over the first edge, if the first edge is the top edge of the rail). The user then begins pressing the rotatable second hook towards the rail. Because the rotatable second hook has an arc of rotation away from the bracket portion, the user can aim the trough of the rotatable second hook for the second edge of the rail. Upon touching the trough to the second edge of the rail, additional pressure from the user (i.e., pressing the bracket clamp towards the rail) causes the rotatable second hook to rotate towards the bracket.

When the rotatable second hook is rotated into position to lock onto the rail (i.e., the trough is lined up with the first hook, with the rail coupled to both the first hook and the rotatable second hook), the rectangular opening of the tongue receives the snap protrusion, such that the snap protrusion locks the rotatable second hook into place. At this point the bracket clamp is locked onto the rail. To release the bracket clamp from the rail, the user pulls on an elastic tab on the outside of the bracket portion. The elastic tab connects to the snap protrusion, such that pulling on the elastic tab pulls the snap protrusion out of the rectangular opening in the tongue, thereby releasing the rotatable second hook to rotate. As the user continues to pull on the bracket clamp, the rotatable second hook will continue to rotate, disengaging from the second edge of the rail, at which point the user can pull the first hook off the first rail, completely decoupling the bracket clamp from the rail.

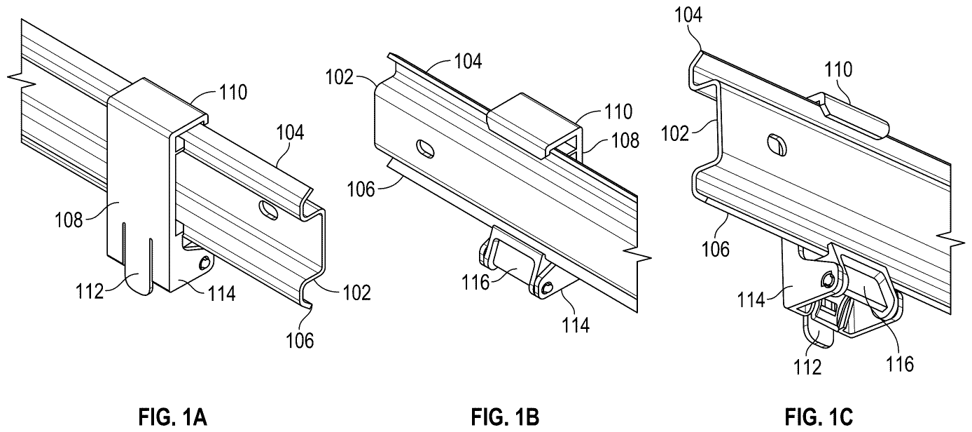

FIG. 1A illustrates a first example of a bracket clamp 108 coupled to a rail 102. As illustrated, the bracket clamp 108 has a first hook 110, which engages with a first edge 104 of the rail 102, an arm 114, and an elastic tab 112.

FIG. 1B illustrates a second example of the bracket clamp 108 engaging the rail 102. From this perspective one can see the rotatable second hook 116 fixed into the arm 114, the rotatable second hook 116 engaging the second edge 106, thereby coupling the bracket clamp 108 to the rail. Also illustrated is the first hook 110 engaging with the first edge 104 of the rail 102.

FIG. 1C illustrates a third example of the bracket clamp 108 engaging the rail 102. In this example, the first hook 110 again engages with the first edge 104 of the rail 102. The rotatable second hook 116 also engages with the second edge 106 of the of the rail 102. The elastic tab 112 is also visible. Notably, there is a gap/space between the elastic tab 112 and the rotatable second hook 116.

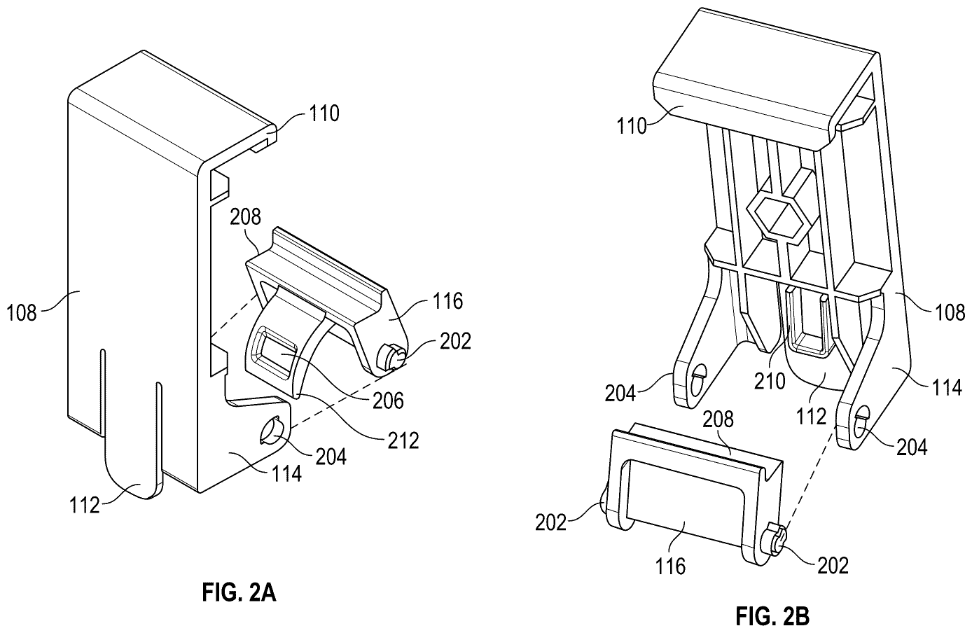

FIG. 2A illustrates a first example of the bracket clamp 108 assembly, with the bracket clamp 108 receiving the rotatable second hook 116. As illustrated, each arm 114 of the bracket clamp 108 has a specially shaped hole 204. Each side of the rotatable second hook 116 has a specially shaped shaft 202. The specially shaped shafts 202 fit into the specially shaped holes 204, coupling the rotatable second hook 116 to the arms 114 of the bracket clamp 108. Also illustrated is the trough 208 of the rotatable second hook 116, configured to receive the second edge of the rail. In addition, the rotatable second hook 116 has a tongue 212, in which is a rectangular opening 206.

FIG. 2B illustrates a second example of the bracket clamp 108 assembly. In addition to those elements illustrated in FIG. 2A, from this view one can see the snap protrusion 210, attached to the elastic tab 112.One can also see that there are arms 114 on both sides of the bracket clamp 108, with each arm 114 having a hole 204 to receive a shaft 202 on the rotatable second hook 116.

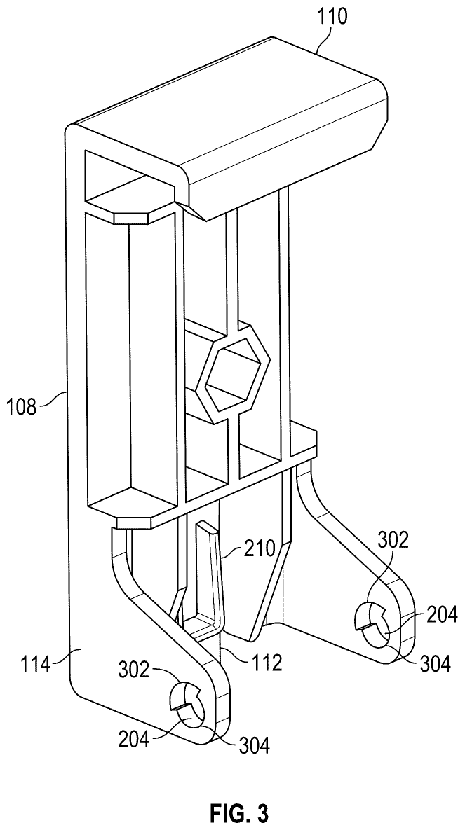

FIG. 3 illustrates an example of the bracket clamp 108 without a lower hook. While many of the features illustrated are illustrated in FIG. 2B, FIG. 3 particularly illustrates the specifically shaped holes 204. Each specifically shaped hole 204 is formed as a first circle 304, with a second/additional/larger semi-circle 302 contiguous to the first circle 304, both the first circle 304 and the second/additional/larger semi-circle 302 having a common center. When the shafts 202 of the rotatable second hook are placed into the holes 204, the arc of rotation of the rotatable second hook is limited based on the difference in second/additional/larger semi-circle 302 and the corresponding portion within the shafts 202.

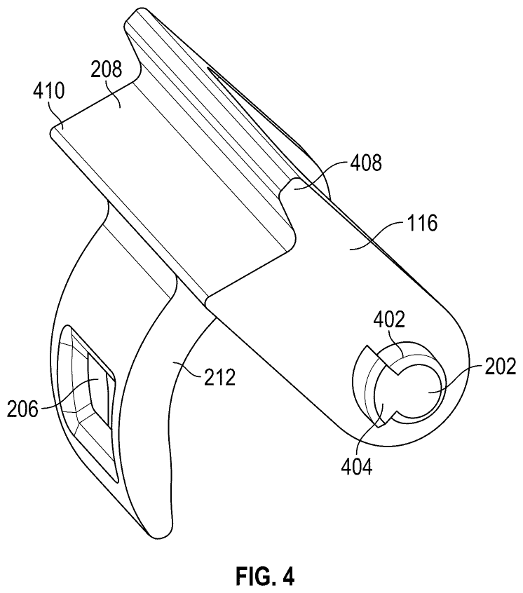

FIG. 4 illustrates an example of a rotatable second hook 116. As illustrated, the lower hook 116 has a trough 208 for receiving/engaging the second edge of the rail. The trough 208 is located between a steep ridge 408 and a lip 410. The steep ridge 408 prevents the second edge of the rail from exiting the trough 208 when the rotatable second hook 116 is locked in place. The lip 410 allows the second edge of the rail to rotate over the lip 410 before engaging with the trough 208.

The tongue 212, as illustrated, has a curve, the curve bending convexly from the main portion of the rotatable second hook 116. In the middle of the tongue 212 is a rectangular opening 206 designed to couple to the snap protrusion 210 (specifically the short edge of the snap protrusion 210). The rectangular opening 206 can, as illustrated, be a gradual opening with a gradient. In other configurations, the rectangular opening 206 can be a sharp edge, or any other configuration which allows the rectangular opening 206 to couple to a protrusion (such as the snap protrusion 210) on the bracket clamp 108.

In addition, FIG. 4 illustrates one of the shafts 202 which extend from the rotatable second hook 116 and fix the rotatable second hook 116 to the holes 204 in the arms 114 of the bracket clamp 108. As illustrated, there is a smaller circle 402 on the shaft 202, with a contiguous larger radius semi-circle 404, the smaller circle 402 and the contiguous larger radius semi-circle 404 having a common center. The arc through which the rotatable second hook 116 can rotate depends on the size of the larger radius semi-circle 404 compared to the size of the second/additional/larger semi-circle 302 of the hole 204.

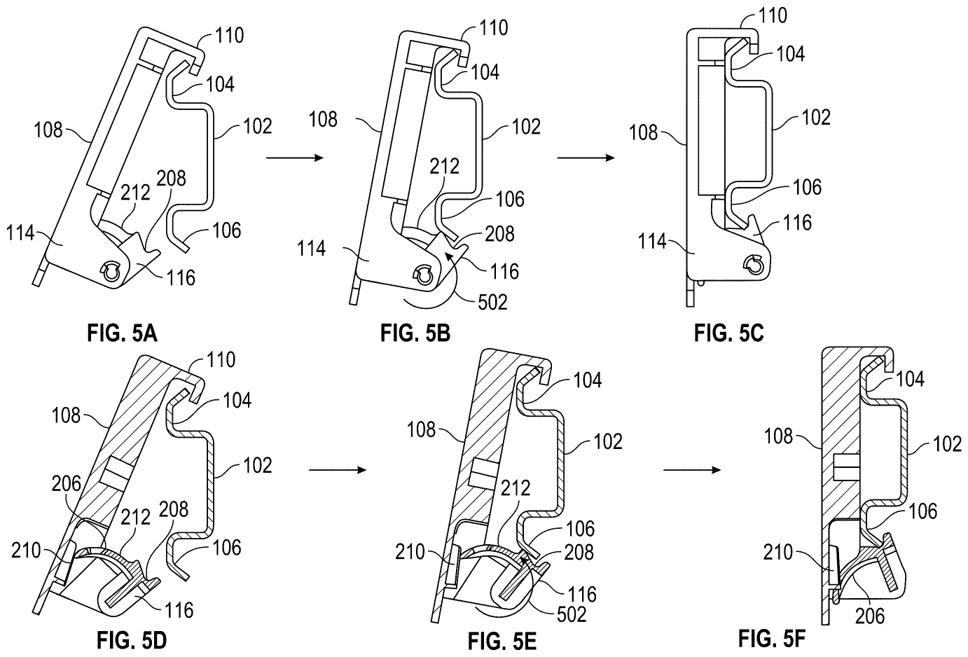

FIG. 5A illustrates an example of a bracket clamp 108 engaging a first edge 104 of a rail 102. As the user places the bracket clamp 108 begins the process of attaching the bracket clamp 108 to the rail 102, the first hook 110 is placed over the first edge 104. At this point, the rotatable second hook 116 is oriented slightly away from the bracket clamp 108.

FIG. 5B illustrates an example of the bracket clamp 108 engaging a second edge 106 of the rail 102, with the trough 208 beginning to engage with the second edge 106. As the user presses on the bracket clamp 108, the rotatable second hook 116 rotates 502, locking the bracket clamp 108 onto the rail 102.

FIG. 5C illustrates an example of the bracket clamp 108 coupled to the first edge 104 and second edge 106 of the rail 102.

FIG. 5D illustrates an example of a segmented bracket clamp 108 engaging a first edge 104 of a rail 102. This figure illustrates the interior of FIG. 5A, illustrating the tongue 212 of the rotatable second hook 116 pressing against the snap protrusion 210, the rectangular opening 206 not yet engaging the snap protrusion 210. There can also be an angled slope to the snap protrusion 210 (e.g., as illustrated, the snap protrusion 210 can become thicker/wider horizontally from the top of the snap protrusion 210 to the bottom of the snap prostration 210), such that when the rotatable second hook 212 is not engaging the rail 102 (and is prevented from further rotation by the shafts 202 and holes 204) the tongue 212 of the rotatable second hook 116 presses against the smaller/top portion of the snap protrusion 210 (which is thinner than the bottom portion, the bottom portion being the part of the snap protrusion 210 which couples to the rectangular opening 206). Thus, the rotatable second hook 116 is held in the correct open position before engaging the rail 102.

FIG. 5E illustrates an example of the segmented bracket clamp 108 engaging a second edge 106 of the rail 102. This figure illustrates the interior of FIG. 5B, illustrating the tongue 212 of the rotatable second hook 116 pressing against the snap protrusion 210, the rectangular opening 206 not yet engaging the snap protrusion 210.

FIG. 5F illustrates an example of the segmented bracket clamp 108 coupled to the first edge 104 and second edge 106 of the rail 102. This figure illustrates the interior of FIG. 5C, illustrating the tongue 212 of the rotatable second hook 116 coupled to the snap protrusion 210, the rectangular opening 206 engaging the snap protrusion 210, thereby locking the bracket clamp 108 to the rail 102.

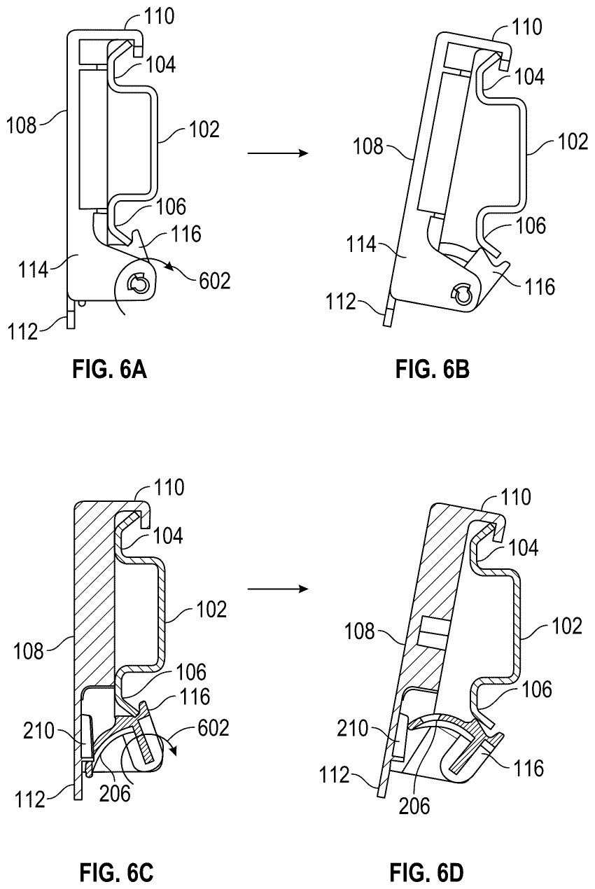

FIG. 6A illustrates a first example of a bracket clamp 108 disengaging the second edge 106 of the rail 102. When a user pulls on the elastic tab 112, it disengages the snap protrusion 210 from the rectangular opening 206, allowing the rotatable second hook 116 to rotate 602.

FIG. 6B illustrates a second example of the bracket clamp 108 disengaging the second edge 106 of the rail 102, with the rotatable second hook 116 now rotated to the point that the second edge 106 is no longer coupled to the bracket clamp 108.

FIG. 6C illustrates a first example of a segmented bracket clamp 108 disengaging the second edge 106 of the rail 102. This figure illustrates the interior of FIG. 6A, illustrating the rectangular opening 206 engaging with the snap protrusion 210. Again, as the user pulls on the elastic tab 112, the snap protrusion 210 moves with the elastic tab 112, disengaging the rectangular opening 206, allowing for rotation of the rotatable second hook 116.

FIG. 6D illustrates a second example of the segmented bracket clamp disengaging the second edge of the rail. This figure illustrates the interior of FIG. 6B, with the rotatable second hook 116 now rotated to the point that the second edge 106 is no longer coupled to the bracket clamp 108, and further illustrating that the rectangular opening 206 is no longer catching on the snap protrusion 210. As discussed above, there can also be an angled slope to the snap protrusion 210 (e.g., as illustrated, the snap protrusion 210 can become thicker/wider horizontally from the top of the snap protrusion 210 to the bottom of the snap prostration 210). When disengaging the bracket clamp 108 from the rail 102, user pulls on the elastic tab 112, releasing the tongue 212 from the snap protrusion 210. As a result, the tongue 212 moves along the snap protrusion 210 (from thicker to thinner portions of the snap protrusion 210) while at the same time the rotatable second hook 116 rotates, disengaging the rail 102. The rotation of the rotatable second hook 116 (and the movement of the tongue 112 along the snap protrusion 210) stops based on the shafts 202 and holes 204, as discussed above. Upon reaching maximum rotation, the tongue 212 of the rotatable second hook 116 presses against the smaller/top portion of the snap protrusion 210 Thus, the rotatable second hook 116 is held in the correct open position after engaging the rail 102 until a subsequent use.

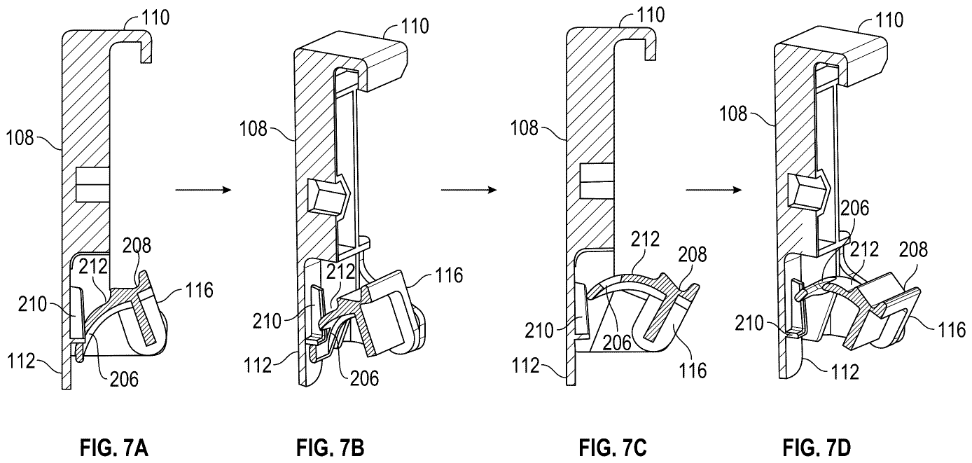

FIG. 7A illustrates an example side view of a segmented bracket clamp 108 with the tongue 212 locked in place, the rectangular opening 206 catching on the snap protrusion 210.

FIG. 7B illustrates an example perspective view of a segmented bracket clamp 108 with the tongue 212 locked in place. Clear between FIGS. 7A and 7B is the three-dimensional nature of the snap protrusion 210.

FIG. 7C illustrates an example side view of a segmented bracket clamp 108 with the rotatable second hook 116 in an open position, no longer rotating open (due to the specifically shaped shafts 202), with the tongue 212 pressing against the snap protrusion 210, thereby holding the rotatable second hook 116 in position until the user provides pressure.

FIG. 7D illustrates an example perspective view of a segmented bracket clamp 108 with rotatable second hook 116 in an open position.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A bracket clamp for engaging with a rail, the bracket clamp comprising: a bracket comprising: a first side which, while the bracket clamp engages the rail, is oriented toward the rail; a second side which, while the bracket clamp engages the rail, is oriented away from the rail; and a snap protrusion extending from the first side; a first hook attached to a first end of the bracket, the first hook configured to be placed over a first edge of the rail; a rotatable second hook attached to a second end of the bracket, wherein: the rotatable second hook is configured to: engage with a second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket, the tongue coupling with the snap protrusion when the bracket clamp engages the rail.

The bracket clamp of any preceding clause, the bracket further comprising: an elastic arm which couples to the rotatable second hook when the rotatable second hook engages the second edge of the rail, wherein when a user pulls on the elastic arm the rotatable second hook disengages from the second edge of the rail.

The bracket clamp of any preceding clause, wherein the user pulling on the elastic arm disengages the snap protrusion from the tongue.

The bracket clamp of any preceding clause, wherein: the bracket clamp further comprises, at the second end of the bracket, a pair of arms extending from the first side, wherein each arm in the pair of arms defines a hole, resulting in a pair of holes; the rotatable second hook further comprises a pair of shafts; and the pair of shafts of the rotatable second hook fit within the pair of holes, coupling the rotatable second hook to the bracket.

The bracket clamp of any preceding clause, wherein the pair of shafts and the pair of holes are configured to fix an arc of possible rotation of the rotatable second hook.

The bracket clamp of any preceding clause, wherein the arc of possible rotation of the rotatable second hook is 45°.

The bracket clamp of any preceding clause, wherein the tongue maintains the rotatable second hook in an open position prior to engaging with the second edge of the rail.

The bracket clamp of any preceding clause, wherein the tongue comprises a rectangular opening, wherein the snap protrusion couples to the tongue by fitting into the rectangular opening.

A wall storage system comprising: a rail, the rail comprising: a first edge of the rail; and a second edge of the rail; and a bracket clamp, the bracket clamp comprising: a first side which, while the bracket clamp engages the rail, is oriented toward the rail; a second side which, while the bracket clamp engages the rail, is oriented away from the rail; and a snap protrusion extending from the first side; a first hook attached to a first end of the bracket clamp, the first hook configured to be placed over the first edge of the rail; a rotatable second hook attached to a second end of the bracket clamp, wherein the rotatable second hook is configured to: engage with the second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket clamp, the tongue coupling with the snap protrusion when the bracket clamp engages the rail.

The wall storage system of any preceding clause, the bracket clamp further comprising: an elastic arm which couples to the rotatable second hook when the rotatable second hook engages the second edge of the rail, wherein when a user pulls on the elastic arm the rotatable second hook disengages from the second edge of the rail.

The wall storage system of any preceding clause, wherein the user pulling on the elastic arm disengages the snap protrusion from the tongue.

The wall storage system of any preceding clause, wherein: the bracket clamp further comprises, at the second end of the bracket clamp, a pair of arms extending from the first side, wherein each arm in the pair of arms defines a hole, resulting in a pair of holes; the rotatable second hook further comprises a pair of shafts; and the pair of shafts of the rotatable second hook fit within the pair of holes, coupling the rotatable second hook to the bracket clamp.

The wall storage system of any preceding clause, wherein the pair of shafts and the pair of holes are configured to fix an arc of possible rotation of the rotatable second hook.

The wall storage system of any preceding clause, wherein the arc of possible rotation of the rotatable second hook is 45°.

The wall storage system of any preceding clause, wherein the tongue maintains the rotatable second hook in an open position prior to engaging with the second edge of the rail.

The wall storage system of any preceding clause, wherein the tongue comprises a rectangular opening, wherein the snap protrusion couples to the tongue by fitting into the rectangular opening.

A bracket clamp for engaging with a rail, the bracket clamp comprising: a first side which, while the bracket clamp engages the rail, is oriented toward the rail; a second side which, while the bracket clamp engages the rail, is oriented away from the rail; and a snap protrusion extending from the first side; a first hook attached to a first end of the bracket clamp, the first hook configured to be placed over a first edge of the rail; a rotatable second hook attached to a second end of the bracket clamp, wherein the rotatable second hook is configured to: engage with a second edge of the rail; and to rotate while engaging or disengaging the second edge of the rail, the rotatable second hook comprising: a trough which contacts the second edge while the rotatable second hook engages with the second edge of the rail; and a tongue which contacts the first side of the bracket clamp, the tongue coupling with the snap protrusion when the bracket clamp engages the rail, the tongue maintaining the rotatable second hook in an open position prior to engaging with the second edge of the rail, the tongue comprises a rectangular opening such that the snap protrusion couples to the tongue by fitting into the rectangular opening.

The bracket clamp of any preceding clause, the bracket clamp further comprising: an elastic arm which couples to the rotatable second hook when the rotatable second hook engages the second edge of the rail, wherein when a user pulls on the elastic arm the rotatable second hook disengages from the second edge of the rail.

The bracket clamp of any preceding clause, wherein the user pulling on the elastic arm disengages the snap protrusion from the tongue.

The bracket clamp of any preceding clause, wherein: the bracket clamp further comprises, at the second end of the bracket, a pair of arms extending from the first side, wherein each arm in the pair of arms defines a hole, resulting in a pair of holes; the rotatable second hook further comprises a pair of shafts; and the pair of shafts of the rotatable second hook fit within the pair of holes, coupling the rotatable second hook to the bracket.

We claim:

1. A bracket clamp for engaging with a rail, the bracket clamp comprising:
a bracket comprising:
a first side which, while the bracket clamp engages the rail, is oriented toward the rail;
a second side which, while the bracket clamp engages the rail, is oriented away from the rail; and
a snap protrusion extending from the first side;
a first hook attached to a first end of the bracket, the first hook configured to be placed over a first edge of the rail;
a rotatable second hook attached to a second end of the bracket, wherein:
the rotatable second hook is configured to:
engage with a second edge of the rail; and
to rotate while engaging or disengaging the second edge of the rail,
the rotatable second hook comprising:
a trough which contacts the second edge while the rotatable second hook engages with the second edge of the rail; and
a tongue which contacts the first side of the bracket, the tongue coupling with the snap protrusion when the bracket clamp engages the rail.

2. The bracket clamp of claim 1, the bracket further comprising:
an elastic arm which couples to the rotatable second hook when the rotatable second hook engages the second edge of the rail, wherein when a user pulls on the elastic arm the rotatable second hook disengages from the second edge of the rail.

3. The bracket clamp of claim 2, wherein the user pulling on the elastic arm disengages the snap protrusion from the tongue.

4. The bracket clamp of claim 1, wherein:
the bracket clamp further comprises, at the second end of the bracket, a pair of arms extending from the first side, wherein each arm in the pair of arms defines a hole, resulting in a pair of holes;
the rotatable second hook further comprises a pair of shafts; and
the pair of shafts of the rotatable second hook fit within the pair of holes, coupling the rotatable second hook to the bracket.

5. The bracket clamp of claim 4, wherein the pair of shafts and the pair of holes are configured to fix an arc of possible rotation of the rotatable second hook.

6. The bracket clamp of claim 5, wherein the arc of possible rotation of the rotatable second hook is 45°.

7. The bracket clamp of claim 1, wherein the tongue maintains the rotatable second hook in an open position prior to engaging with the second edge of the rail.

8. The bracket clamp of claim 1, wherein the tongue comprises a rectangular opening, wherein the snap protrusion couples to the tongue by fitting into the rectangular opening.

9. A wall storage system comprising:
a rail, the rail comprising:
a first edge of the rail; and
a second edge of the rail; and
a bracket clamp, the bracket clamp comprising:
a first side which, while the bracket clamp engages the rail, is oriented toward the rail;
a second side which, while the bracket clamp engages the rail, is oriented away from the rail; and
a snap protrusion extending from the first side;
a first hook attached to a first end of the bracket clamp, the first hook configured to be placed over the first edge of the rail;
a rotatable second hook attached to a second end of the bracket clamp, wherein
the rotatable second hook is configured to:
engage with the second edge of the rail; and
to rotate while engaging or disengaging the second edge of the rail,
the rotatable second hook comprising:
a trough which contacts the second edge while the rotatable second hook engages with the second edge of the rail; and
a tongue which contacts the first side of the bracket clamp, the tongue coupling with the snap protrusion when the bracket clamp engages the rail.

10. The wall storage system of claim 9, the bracket clamp further comprising:
an elastic arm which couples to the rotatable second hook when the rotatable second hook engages the second edge of the rail, wherein when a user pulls on the elastic arm the rotatable second hook disengages from the second edge of the rail.

11. The wall storage system of claim 10, wherein the user pulling on the elastic arm disengages the snap protrusion from the tongue.

12. The wall storage system of claim 9, wherein:
the bracket clamp further comprises, at the second end of the bracket clamp, a pair of arms extending from the first side, wherein each arm in the pair of arms defines a hole, resulting in a pair of holes;
the rotatable second hook further comprises a pair of shafts; and
the pair of shafts of the rotatable second hook fit within the pair of holes, coupling the rotatable second hook to the bracket clamp.

13. The wall storage system of claim 12, wherein the pair of shafts and the pair of holes are configured to fix an arc of possible rotation of the rotatable second hook.

14. The wall storage system of claim 13, wherein the arc of possible rotation of the rotatable second hook is 45°.

15. The wall storage system of claim 9, wherein the tongue maintains the rotatable second hook in an open position prior to engaging with the second edge of the rail.

16. The wall storage system of claim 9, wherein the tongue comprises a rectangular opening, wherein the snap protrusion couples to the tongue by fitting into the rectangular opening.

17. A bracket clamp for engaging with a rail, the bracket clamp comprising:
a first side which, while the bracket clamp engages the rail, is oriented toward the rail;
a second side which, while the bracket clamp engages the rail, is oriented away from the rail; and
a snap protrusion extending from the first side;
a first hook attached to a first end of the bracket clamp, the first hook configured to be placed over a first edge of the rail;
a rotatable second hook attached to a second end of the bracket clamp, wherein the rotatable second hook is configured to:
engage with a second edge of the rail; and
to rotate while engaging or disengaging the second edge of the rail,
the rotatable second hook comprising:
a trough which contacts the second edge while the rotatable second hook engages with the second edge of the rail; and
a tongue which contacts the first side of the bracket clamp, the tongue coupling with the snap protrusion when the bracket clamp engages the rail, the tongue maintaining the rotatable second hook in an open position prior to engaging with the second edge of the rail, the tongue comprises a rectangular opening such that the snap protrusion couples to the tongue by fitting into the rectangular opening.

18. The bracket clamp of claim 17, the bracket clamp further comprising:
an elastic arm which couples to the rotatable second hook when the rotatable second hook engages the second edge of the rail, wherein when a user pulls on the elastic arm the rotatable second hook disengages from the second edge of the rail.

19. The bracket clamp of claim 18, wherein the user pulling on the elastic arm disengages the snap protrusion from the tongue.

20. The bracket clamp of claim 17, wherein:
the bracket clamp further comprises, at the second end of the bracket, a pair of arms extending from the first side, wherein each arm in the pair of arms defines a hole, resulting in a pair of holes;
the rotatable second hook further comprises a pair of shafts; and
the pair of shafts of the rotatable second hook fit within the pair of holes, coupling the rotatable second hook to the bracket.
